(19) United States
(12) Patent Application Publication
(10) Pub. No.: US 2026/0310451 A1
(43) Pub. Date: Oct. 8, 2026

(54) APPARATUS AND METHOD FOR MANAGING OPERATING SYSTEM BASED ON AI AGENT

(71) Applicant: ELECTRONICS AND TELECOMMUNICATIONS RESEARCH INSTITUTE, Daejeon (KR)

(72) Inventor: Sang-Cheol KIM, Daejeon (KR)

(73) Assignee: ELECTRONICS AND TELECOMMUNICATIONS RESEARCH INSTITUTE, Daejeon (KR)

(21) Appl. No.: 19/635,931

(22) Filed: Apr. 1, 2026

(30) Foreign Application Priority Data
Apr. 3, 2025 (KR) 10-2025-0043729
Mar. 20, 2026 (KR) 10-2026-0050365

(51) Int. Cl. G06F 8/70; G06F 8/35

(52) U.S. Cl. CPC G06F 8/70; G06F 8/35

(57) ABSTRACT

Disclosed herein is an apparatus and method for managing an operating system based on an AI agent. The apparatus may include an AI natural language interface for recognizing a natural language command input from a user, an agent unit for determining a task corresponding to the natural language command received from the AI natural language interface, an AI model-based engine for generating and optimizing command code corresponding to the task determined by the agent unit using an AI model, and an operating system automatic execution management unit for executing the command code generated by the AI model-based engine in an actual operating system and providing execution results to the agent unit as feedback.

### CROSS REFERENCE TO RELATED APPLICATIONS

This application claims the benefit of Korean Patent Applications No. 10-2025-0043729, filed Apr. 3, 2025, and No. 10-2026-0050365, filed Mar. 20, 2026, which are hereby incorporated by reference in their entireties into this application.

### BACKGROUND OF THE INVENTION

### 1. Technical Field

The disclosed embodiment relates generally to technology for managing an Operating System (OS) and applications, and more particularly to technology for controlling, automating, optimizing, and recovering an operating system and applications using Artificial Intelligence (AI) and Natural Language Processing (NLP).

### 2. Description of the Related Art

In modern computing environments, user interfaces for controlling operating systems and applications are mainly provided in two forms: a Command Line Interface (CLI) and a Graphical User Interface (GUI).

However, these conventional interfaces have several limitations.

Although the CLI method is powerful and flexible, users are required to learn complex command syntaxes and options, and incorrect command input may cause significant changes to the system.

The GUI method is designed to be more intuitive but has limitations in changing complex settings or performing multiple system tasks collectively. In addition, users can perform operations only through predefined menus or buttons, making it difficult to perform fine adjustments depending on circumstances.

Due to the limitations of the existing interfaces, there has been a growing need for a more natural interaction method. Users want to control computer systems as if speaking to a person, and advancements in natural language processing technology play a key role in achieving this.

In particular, Large Language Models (LLMs), which have recently emerged with advances in the field of artificial intelligence, demonstrate language understanding and generation capabilities comparable to those of humans, and attempts to apply the LLMs to operating system management are attracting attention.

According to such attempts, several voice assistants and chatbot systems have been developed to perform basic system commands through a web browser, but they are generally limited to a predefined set of commands, or it is difficult to guarantee accurate operation in complex scenarios.

For example, most conventional AI-based conversational systems merely provide a user with a method for managing a system. The user understands the text generated by AI-based conversational systems and configures the system using the text at the user's own risk. One of the reasons why this approach remains at a semi-automation level that requires manual intervention, such as reading generated text and configuring the system, rather than a fully automated level, is that current AI services still exhibit hallucinations.

### SUMMARY OF THE INVENTION

An object of the disclosed embodiment is to minimize hallucinations by optimizing a large language model (LLM) for operating system management and to provide a fully automated system that automatically converts user requests into code and executes the code at the operating system level in consideration of currently available information acquired through retrieval-augmented generation (RAG).

Another object of the disclosed embodiment is to control an operating system and applications by understanding natural language commands from a user and to automatically generate and execute code corresponding to the command using an AI model, thereby efficiently automating management tasks.

A further object of the disclosed embodiment is to automatically and intelligently perform various operating system management functions, such as intrusion detection, system settings recovery, and software package management, and to improve system performance and accuracy through AI model-based optimization and continuous learning.

An apparatus for managing an operating system based on an AI agent according to an embodiment may include an AI natural language interface for recognizing a natural language command input from a user, an agent unit for determining a task corresponding to the natural language command received from the AI natural language interface, an AI model-based engine for generating and optimizing command code corresponding to the task determined by the agent unit using an AI model, and an operating system automatic execution management unit for executing the command code generated by the AI model-based engine in an actual operating system and providing an execution result to the agent unit as feedback.

Here, the agent unit may include a chatbot conversation interface for interacting with the user in natural language, and the chatbot conversation interface may extract an intent and key information from a natural language input from the user and generate a response while maintaining the context of a previous conversation.

Here, the agent unit may include a plurality of domain-specific agents.

Here, the agent unit may perform registration, deletion, state monitoring, and role allocation of the plurality of agents.

Here, the agent unit may split a user request into a plurality of tasks, establish an execution plan, and determine sequential execution or parallel execution by analyzing dependencies among the tasks.

Here, the AI model-based engine may automatically adjust the structure of the command code corresponding to the natural language command from the user according to the type of the operating system and an operating environment.

Here, the AI model-based engine may remove unnecessary commands from the generated command code and reorder an execution order.

Here, the AI model-based engine may analyze system resource access, file modification, network communication, process creation, or privilege escalation requests included in the generated command code and determine whether a risk exists by comparing the requests with a preset security policy.

Here, the AI model-based engine may verify whether abnormal behavior occurs by executing the command code in an isolated sandbox environment.

Here, the AI model-based engine may perform a test run of the command code in a virtual environment similar to an actual operating system environment and then transmit the command code to the operating system automatic execution management unit.

Here, the AI model-based engine may search internal system data and an external database and reflect a search result in generating the command code.

Here, the AI model included in the AI model-based engine may be finetuned based on user behavior patterns and system usage patterns and may be made lightweight by applying quantization or knowledge distillation techniques.

Here, the operating system automatic execution management unit may detect an error during code execution and perform automatic recovery or rollback when an error occurs.

Here, the operating system automatic execution management unit may detect a system security event and block abnormal access or processes.

Here, the apparatus for managing an operating system based on an AI agent according to an embodiment may further include a platform data integrated management unit for collecting and managing system data, operating system data, user data, and platform data.

Here, the platform data integrated management unit may store and analyze, based on the data, a task execution history and a command code generation history of an agent, and security events.

A method for managing an operating system based on an AI agent according to an embodiment may include receiving a natural language command from a user, determining a task corresponding to the natural language command, generating and optimizing command code corresponding to the task based on an AI model, executing the generated command code in an actual operating system, and providing an execution result to the user as feedback.

Here, determining the task may include performing registration, deletion, state monitoring, and role allocation of a plurality of domain-specific agents, splitting a user request into a plurality of tasks, establishing an execution plan, and determining sequential execution or parallel execution by analyzing dependencies among the tasks.

Here, generating and optimizing the command code may include automatically adjusting the structure of the command code corresponding to the natural language command from the user according to the type of the operating system and an operating environment, determining whether a risk exists by analyzing system resource access, file modification, network communication, process creation, or privilege escalation requests included in the generated command and by comparing the requests with a preset security policy, verifying whether abnormal behavior occurs by executing the command code in an isolated sandbox environment, and searching internal system data and an external database and reflecting a search result in generating the command code.

Here, executing the generated command code in the actual operating system may include detecting an error during code execution and performing automatic recovery or rollback when the error occurs; and detecting a system security event and blocking abnormal access or processes.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram for explaining an apparatus for managing an operating system based on an AI agent according to an embodiment;

FIG. 2 is a flowchart for explaining a method for managing an operating system based on an AI agent according to an embodiment;

FIG. 3 is a block diagram illustrating in detail the internal configuration of an apparatus for managing an operating system based on an AI agent according to an embodiment;

FIG. 4 is a flowchart for explaining a detailed operation of an AI model-based engine according to an embodiment;

FIG. 5 is a flowchart for explaining a process in which AI learns task patterns of an operating system and provides optimal code execution and resource utilization methods according to an embodiment; and

FIG. 6 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

As the complexity of IT infrastructure has recently increased, operating system management tasks have increased in scale, and management of multiple servers, various applications, and frequent software updates and security patches is required. Since existing manual management methods involve a high workload and the possibility of errors, there is a need for automated operating system management methods that combine a natural language interface with AI technology.

The present disclosure proposes an architecture configured to optimize a large language model (LLM) for operating system management and to automatically convert a user request into executable code and execute the code at the operating system level while referencing the latest system status information and external data by applying a retrieval-augmented generation (RAG) technique. Accordingly, the possibility of hallucinations may be reduced, and the reliability and safety of code generation may be ensured.

Also, the present disclosure applies techniques for model compression, fine-tuning, and optimization of an AI model such that the AI model can operate not only in server environments but also in personal computers and resource-constrained embedded environments. In particular, a small language model is also trained, and quantization or knowledge distillation techniques are applied, thereby enabling efficient execution even in resource-constrained environments.

Meanwhile, in the present disclosure, AI-generated code is directly executed at the operating system level, and thus a verification procedure for ensuring the accuracy and security of the code is required. To this end, the present disclosure includes static analysis of the generated code, verification in an isolated environment, and a structure for continuously reflecting execution results in training, thereby maintaining the reliability of the system.

Hereinafter, an embodiment of the present disclosure will be described in more detail with reference to the accompanying drawings.

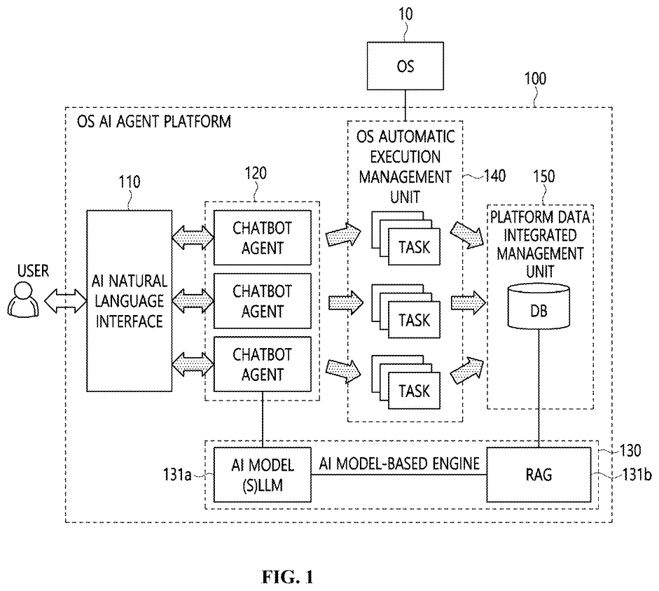

FIG. 1 is a block diagram for explaining an apparatus for managing an operating system based on an AI agent according to an embodiment.

Referring to FIG. 1, the apparatus for managing an operating system based on an AI agent according to an embodiment may include an AI natural language interface 110, an agent unit 120, an AI model-based engine 130, an operating system (OS) automatic execution management unit 140, and a platform data integrated management unit 150.

The AI natural language interface 110 may recognize a natural language command input from a user. That is, the natural language command from the user is transmitted to the agent unit 120 via the AI natural language interface 110 and is processed. That is, the AI natural language interface 110 supports the user in controlling an operating system and applications using natural, conversational language, thereby enabling even non-experts to easily manage the system.

The agent unit 120 determines a task corresponding to the natural language command received from the AI natural language interface 110. Namely, the agent unit 120 analyzes the user command, determines a task to be performed, and transmits the task to the AI model-based engine 130. Here, the agent unit 120 may provide a chatbot-based system control environment that is configured to interpret user commands using an AI-based agent and automatically perform appropriate actions.

Here, the agent unit 120 may include a chatbot conversation interface that interacts with a user in natural language.

Also, the agent unit 120 may include a plurality of domain-specific agents. In other words, each of the plurality of domain-specific agents is responsible for a unique domain (e.g., security) in order to execute a user command.

The AI model-based engine 130 may generate and optimize command code corresponding to the task determined by the agent unit 120 using an AI model. That is, the AI model-based engine 130 generates code suitable for the task or configures a system command set suitable for the task and transmits the result to the OS automatic execution management unit 140.

The OS automatic execution management unit 140 may execute the command code generated by the AI model-based engine 130 in the actual operating system and provide execution results to the agent unit 120 as feedback. Specifically, the OS automatic execution management unit 140 executes a user request by executing received code or commands in the actual operating system and provides execution results or status changes as feedback to the agent unit 120 and the platform data integrated management unit 150. That is, an appropriate script or command is automatically generated by interpreting a natural language command from a user using AI models, and the generated script or command is safely executed, thereby automating operating system management tasks.

The platform data integrated management unit 150 provides various kinds of data collected from the operating system and the user to the agent unit 120 and the AI model-based engine 130, thereby assisting in the operation of each module and improving decision-making accuracy.

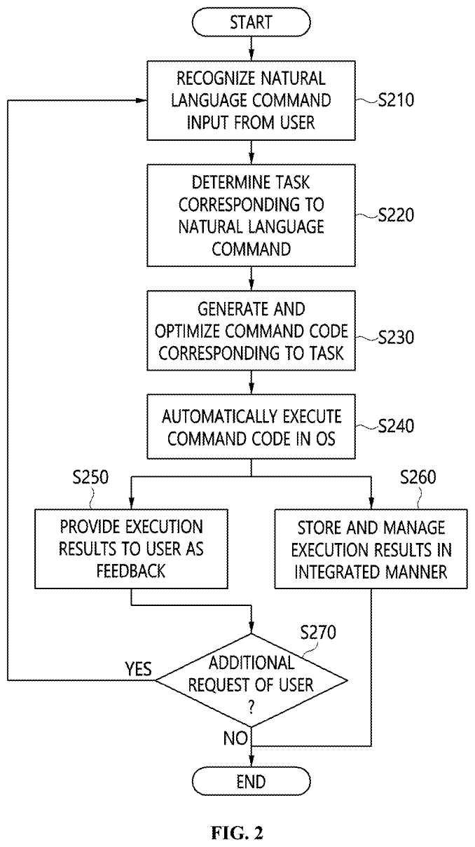

FIG. 2 is a flowchart for explaining a method for managing an operating system based on an AI agent according to an embodiment.

Referring to FIG. 2, the method for managing an operating system based on an AI agent according to an embodiment may include receiving a natural language command from a user at step S210, determining a task corresponding to the natural language command at step S220, generating and optimizing command code corresponding to the task based on an AI model at step S230, executing the generated command code in an actual operating system at step S240, and providing execution results to the user as feedback at step S250.

Here, at the step of receiving a natural language command (S210), the user may input, for example, a natural language command such as “check a server log and analyze errors” in voice or text.

Subsequently, at the step of receiving a natural-language command (S210), the AI natural language interface 110 interprets the received natural language command. For example, the AI natural language interface 110 recognizes that it is necessary to retrieve a server log file and analyze error patterns based on the natural language command in the example above.

Subsequently, at the step of determining a task (S220), the agent unit 120 defines a task and prepares for execution. For example, the agent unit 120 may generate two tasks: “server log retrieval” and “error analysis”. Based on these tasks, the agent unit 120 determines that code execution by the AI model-based engine 130 is required, and transmits an execution request to the AI model-based engine 130.

Accordingly, at the step of generating and optimizing command code (S230), the AI model-based engine 130 generates a suitable command based on the operating system environment. For example, in a Linux environment, a Bash command such as ‘cat /var/log/syslog|grep ERROR’ is generated, and the generated code is optimized and verified, and then transmitted to the OS automatic execution management unit 140.

At the step of executing the generated command code (S240), the OS automatic execution management unit 140 executes the AI-generated code in the operating system and transmits execution results such as error patterns identified in log data to the platform data integrated management unit 150 and the agent unit 120.

Accordingly, at the step of providing the execution results as feedback (S250), the agent unit 120 provides the execution results to the user in natural language. For example, analyzed error patterns may be provided in the form of a message such as “Three serious errors are found in the server log. The details are as follows: . . . ”.

Here, when the user requests an additional action at step S270, the process may return to step S210 and be performed again. For example, when the user makes an additional request such as “propose a solution to the errors”, an appropriate solution may be recommended using AI model. A response such as “The found errors appear to be caused by a network connection problem. Do you want to know how to reconfigure network settings?” may be provided.

Finally, the execution data and feedback are used as training data to continuously train the AI model, thereby improving the accuracy and efficiency of the system.

Meanwhile, the method for managing an operating system based on an AI agent according to an embodiment may further include performing data analysis and training at step S260 by the platform data integrated management unit 150. That is, AI model stores log analysis results and accumulates data to enable more precise analysis when a similar request is made in the future.

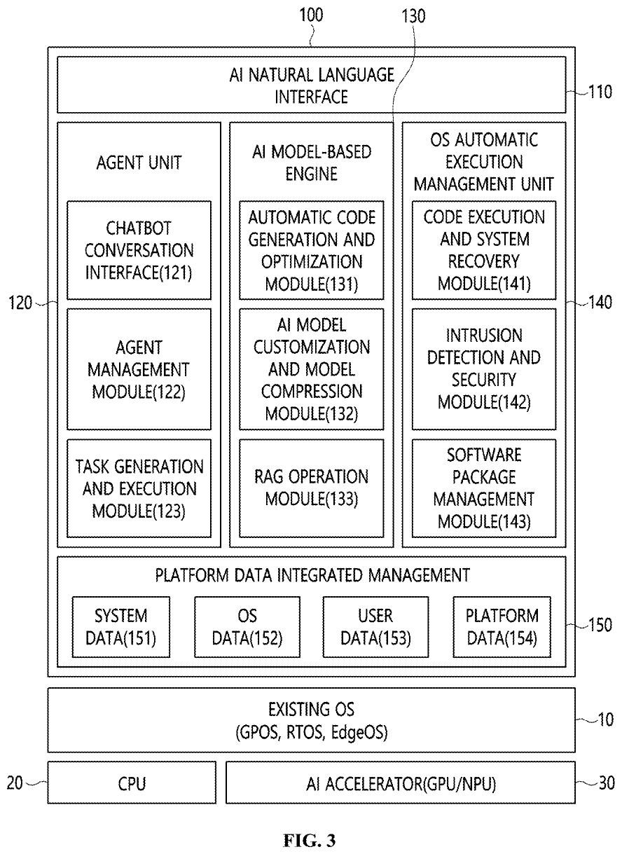

FIG. 3 is a block diagram illustrating in detail the internal configuration of an apparatus for managing an operating system based on an AI agent according to an embodiment.

Referring to FIG. 3, the AI natural language interface 110 is a module that receives a user command or query in natural language in the form of voice or text and interprets the command or query.

The AI natural language interface 110 analyzes user intent using natural language processing technology and converts the command into a format understandable and executable by an operating system based on the extracted intent and key information. Accordingly, the user may control the operating system using natural language without the need to learn complex commands.

Table 1 below shows examples of representative natural language commands that can be provided to the operating system AI agent.

The commands may include various categories such as system management, automation and optimization, security and patch management, software and package management, and AI model training and user-specific settings.

TABLE 1

| Category | Example commands |
|---|---|
| System | “Check the system status”, “Analyze CPU usage and memory usage”, |
| management | “Check disk usage and recommend files to clean up”, “Show processes |
| | running in the background”, “Check the current network status and measure |
| | network speed” |
| Automation and | “Terminate unnecessary processes and optimize system performance”, |
| optimization | “Configure periodic log file cleanup”, “Recommend methods to optimize |
| | operating system boot speed”, “Adjust resource priorities based on |
| | frequently used programs” |
| Security and | “Check and apply recent security patches”, “Enhance security settings of the |
| patch | operating system”, “Inspect firewall settings and analyze vulnerabilities”, |
| management | “Analyze recent security event logs”, “Check whether any viruses or |
| | malware are running” |
| Software and | “Show a list of installed programs”, “Identify unnecessary programs and |
| package | recommend whether to remove them”, “Update all software to the latest |
| management | version”, “Find packages incompatible with the operating system”, |
| | “Automatically configure a required development environment” |
| AI model | “Analyze frequently used command patterns and recommend automation”, |
| training and | “Show the most frequently executed tasks over the past month”, “Propose |
| user-specific | system optimization methods based on learned data”, “Analyze usage |
| settings | patterns and apply personalized settings” |

The commands in Table 1 are only examples and may be extended according to various operating environments and requirements.

The agent unit 120 illustrated in FIG. 3 is a component configured to generate a task based on the interpreted user request and manage execution of the task, and may include a chatbot conversation interface 121, an agent management module 122, and a task generation and execution module 123.

The chatbot conversation interface 121, which interacts with a user in natural language, receives a user query or request, analyzes the query or request, and plans and generates an appropriate task. The chatbot conversation interface 121 converts the natural language input from the user into a machine-processable format and provides task execution results to the user in natural language that is easily understandable.

Here, natural language understanding (NLU) includes extracting intent and key information (entities) from a user sentence. For example, when a command such as “check a server log” is input, the intent of the sentence is to check a server log, and the server log is identified as a target.

Specifically, the chatbot conversation interface 121 may perform functions including the following.

First, as a question-and-answer processing function, the chatbot conversation interface 121 generates a response to a user question or retrieves and provides information corresponding to a command, and may refer to a knowledge base or a database when necessary.

Second, as a conversation flow management function, when a plurality of question-and-answer interactions are consecutively performed, the chatbot conversation interface 121 maintains context based on previous conversation content and consistently responds to additional questions or instructions. For example, even when a user refers to a previously mentioned task and requests “show that again”, the chatbot conversation interface 121 may appropriately process the request by reflecting the previous context.

Third, as a command conversion function, the chatbot conversation interface 121 converts a natural language request of a user into a command or task unit executable in the operating system and links the conversion result to an internal program call or script execution.

Meanwhile, the agent management module 122 coordinates priorities and progress of a plurality of tasks and executes tasks in parallel as needed, thereby controlling execution of the tasks. Further, the agent management module 122 may monitor intermediate results during execution of the tasks, collect results of completed tasks, and provide the collected results or determine a subsequent action.

The agent management module 122 is a component configured to comprehensively manage a plurality of AI agents within the operating system. Here, the agents refer to independent AI processes that operate for specific functions or domains and may interpret user commands based on AI language models and perform tasks corresponding to the commands.

The agent management module 122 manages the lifecycle of each agent, including generation, execution, suspension, and termination, and adjusts role allocation among a plurality of agents. In an operating system management environment, tasks having different characteristics, such as security, system resource management, and package management, exist, and thus a plurality of agents optimized for respective domains are operated, thereby ensuring task-specific expertise.

In particular, when a single agent performs all functions, a lack of information or hallucinations may occur due to limitations in input tokens of a language model, which limit the range of information that can be referenced. Accordingly, a plurality of agents specialized for respective domains are employed and a domain-specific agent having improved expertise is selectively invoked as needed, whereby the accuracy and reliability of tasks may be ensured. Also, a plurality of small language models are arranged based on their roles, whereby efficient operation may be enabled even in resource-constrained environments.

Specifically, the agent management module 122 may perform functions including the following.

First, as an agent registration and deletion function, the agent management module 122 generates and registers a new agent and terminates and removes an unnecessary agent. A new agent may be added at any time in response to a user request or as required by the system, and an agent that has completed its task is terminated and removed to release resources.

Second, as an execution state monitoring function, the agent management module 122 continuously monitors the execution state, idle state, and resource usage state of each agent, including an overload state, and performs actions such as suspending or resuming execution as needed. For example, the agent management module 122 may restart an agent in which a problem has occurred or suspend some agents when resources are insufficient.

Third, as a role allocation and adjustment function, the agent management module 122 selects an appropriate agent for a specific task from among a plurality of agents, allocates the task to the selected agent, thereby distributing the task load, and controls the integration of results when the task is a composite task.

The task generation and execution module 123 is a component configured to convert a request into task units executable at the operating system level based on a user request or an instruction from an agent and manage execution of generated tasks. The task generation and execution module 123 may be a scheduler that splits a request into specific tasks, determines an execution order, and controls the task execution process.

Specifically, the task generation and execution module 123 may perform functions including the following.

First, as a request analysis and task splitting function, the task generation and execution module 123 analyzes an input request to identify tasks required for the request and determines whether to process the request as a single task or to split the request into a plurality of subtasks. When the request is a composite request, it may be split into a plurality of tasks based on logical or functional units.

Second, as an execution planning function, the task generation and execution module 123 determines the execution order of the identified tasks and the execution method of the tasks. When dependencies exist among the tasks, the execution order may be determined, and independent tasks may be scheduled for parallel execution.

Third, as a task scheduling and execution function, the task generation and execution module 123 executes each task based on the established execution plan and controls resource allocation and execution timing. That is, similar to an operating system scheduler, the task generation and execution module 123 may determine which tasks to execute and which tasks to place in a waiting state.

Fourth, as a state monitoring and completion reporting function, the task generation and execution module 123 continuously monitors the progress of the task and reports task completion and execution results to a higher-level module.

The AI model-based engine 130 illustrated in FIG. 3 is an engine configured to automatically generate and optimize a required script or code using an AI model. The AI model-based engine 130 is based on a large-scale or small-scale AI language model (e.g., a GPT model) using a transformer architecture and may apply domain-specific fine-tuning or model compression (quantization and knowledge distillation). That is, the AI model-based engine 130 trains an AI model in a customized manner for optimal performance in various environments and applies model compression to enable effective operation even in small-scale systems.

Also, the AI model-based engine 130 may generate code directly executable in an operating system by analyzing a natural language command from a user and verify the safety and security of the generated code using static analysis tools (e.g., CodeQL, Semgrep).

Meanwhile, when the AI model-based engine 130 generates code, it may fine-tune or compress a pretrained large-scale AI model for an operating system control task and apply a retrieval-augmented generation (RAG) technique as needed, which retrieves information from an external knowledge base and utilizes the retrieved information, thereby improving the accuracy and efficiency of code generation.

Here, the generated code undergoes an optimization process to reduce unnecessary operations and improve performance, whereby the optimized code is provided to the OS automatic execution management unit.

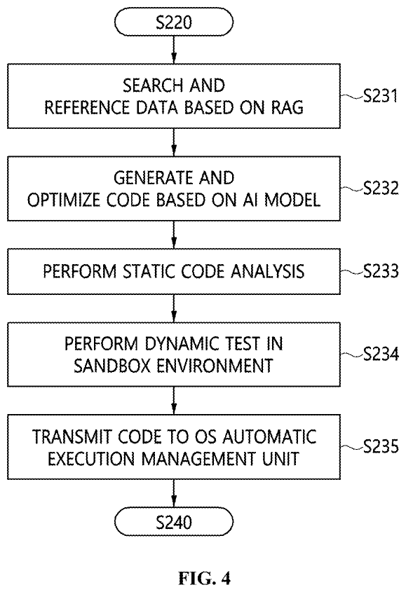

Also, the AI model-based engine 130 continuously trains and improves the model thereof based on data accumulated during operation, so it may improve the precision and efficiency of code generation and system control over time. Furthermore, the AI model may be operated as a user-specific AI model by continuously learning from user data accumulated in an operating system database. The detailed operation of the AI model-based engine 130 will be described later with reference to FIG. 4.

Specifically, the AI model-based engine 130 may include an automatic code generation and optimization module 131, an AI model customization and model compression module 132, and an RAG operation module 133.

The automatic code generation and optimization module 131 is a component configured to automatically generate a script or code executable in an operating system by analyzing a natural language command from a user. The automatic code generation and optimization module 131 is intended to generate code by considering an optimal execution method so as to improve performance, reduce unnecessary operations, and enable secure execution, rather than simply converting a command.

For example, when a user makes a request such as “analyze a system log and find an anomaly pattern”, AI model analyzes the request, selects an appropriate analysis method, and generates code executable in the operating system. The generated code may be in the form of a Python script, a Bash script, or the like, and execution results may be provided to the user. However, Python and Bash are only examples, and various programming languages, including languages requiring compilation, such as C/C++ and Java, may be used for code generation and execution.

Further, a response speed may be improved by applying a caching scheme for a repeatedly used natural language command. When the same or similar command is input again, previously generated execution code and results are retrieved from a cache, thereby reducing unnecessary operations and minimizing system resource usage. For example, when a request such as “analyze the CPU usage for the recent 7 days” is repeated, a response may be immediately provided by using the existing analysis logic and results.

The automatic code generation and optimization module 131 may perform functions including the following.

First, the automatic code generation and optimization module 131 converts a natural language command into executable code, thereby generating code executable in the operating system, such as Bash, Python, PowerShell, or the like.

Second, the automatic code generation and optimization module 131 automatically adjusts a script format and a command structure according to the operating system in which the code is to be executed (e.g., Linux, Windows, RTOS, or EdgeOS), the version of the operating system, and the execution environment.

Third, the automatic code generation and optimization module 131 optimizes the structure of the code to reduce the execution time, memory usage, and CPU usage.

Fourth, the automatic code generation and optimization module 131 reviews the security and permission settings of the generated code so that the code is safely executed.

Fifth, the automatic code generation and optimization module 131 learns from previous execution results and data accumulated in the operating system, thereby gradually improving the quality of the code.

Sixth, the automatic code generation and optimization module 131 caches previous execution results and code for a frequently requested command and performs optimization to quickly return results when the same command is requested again.

Meanwhile, to ensure the safety of AI-generated code, a multi-stage verification procedure may be performed.

First, security vulnerabilities and errors in the code are checked using a static analysis tool.

Subsequently, dynamic analysis and error detection are performed in an isolated sandbox environment under conditions similar to those of the actual operating system.

Subsequently, a test run is performed in a virtual environment similar to the actual system environment before actual operation.

Finally, execution results are reflected in the training data of the AI model, thereby continuously improving the security and reliability of the model.

The AI model customization and model compression module 132 is a component configured to continuously adjust and further optimize an AI model optimized for operating system automation and code generation. By applying model compression to a model trained based on a user environment and requirements, the model may be operated even in a local environment or resource-constrained systems.

For example, a high-performance large language model (LLM) may be used in a data center environment, whereas a lightweight small language model is required in embedded systems or edge computing environments. To this end, a customized model may be trained based on a specific task pattern and data, and quantization and knowledge distillation techniques are applied to improve execution speed and minimize memory usage.

The AI model customization and model compression module 132 may perform the following functions.

First, the AI model customization and model compression module 132 analyzes user request patterns through customized training based on a user and a system and learns frequently executed tasks, thereby generating an AI model specialized for the operating system.

Second, the AI model customization and model compression module 132 optimizes a large language model to convert the model into a lightweight version, thereby improving execution speed and reducing resource consumption.

Third, the AI model customization and model compression module 132 continuously trains and improves the model by analyzing user requests and execution results, thereby gradually improving performance.

Fourth, the AI model customization and model compression module 132 adjusts a model architecture and parameters to be suitable for various operating environments, such as cloud, on-premises, and edge devices.

Fifth, the AI model customization and model compression module 132 improves inference speed by utilizing accelerator hardware, such as GPUs or NPUs, and performs optimization in a form suitable for real-time operating system management.

The retrieval-augmented generation (RAG) operation module 133 is a component configured to support AI model in retrieving information related to an operating system and reflecting the retrieved information in a code generation and execution process while minimizing hallucinations.

That is, AI model-based engine generates a response by retrieving required information from a combination of internal system data, including the latest system state information, an operating system manual, and package update status, and an external database accessible via the Internet, rather than relying only on knowledge within the model. To this end, semantic search and indexing techniques based on vector search are applied, and information with high similarity to a query is extracted in real time based on document embedding. The extracted information is immediately reflected in the code generation process, thereby improving the accuracy and reliability of the generated code.

For example, when a user makes a request such as “back up and store network settings of a current system”, AI model may retrieve network settings information stored in the system and generate and execute an appropriate backup script based on the retrieved information.

The RAG operation module 133 may perform the following functions.

First, the RAG operation module 133 retrieves information within the system, such as operating system settings, a security policy, and a network configuration, thereby enabling AI model to use the retrieved information for code generation and execution.

Second, the RAG operation module 133 retrieves a previous execution history and a task log, thereby proposing an optimal solution in response to a similar request.

Third, the RAG operation module 133 reflects the latest accurate information by linking to an external knowledge database, such as the latest operating system manual, security patch information, and API documents.

Fourth, the RAG operation module 133 improves the accuracy of code generation based on real-time search results. Specifically, rather than using only knowledge of a language model, AI model refers to real-time data based on RAG, thereby improving the reliability and accuracy of a response.

Fifth, the RAG operation module 133 analyzes the current state of the operating system in real time, thereby dynamically adjusting a code generation and execution plan.

Referring again to FIG. 3, the OS automatic execution management unit 140 is a component configured to automatically perform system security management and maintenance tasks.

The OS automatic execution management unit 140 receives code or a command generated by the AI model-based engine 130 and executes the same in the actual operating system environment, thereby performing a user request or periodic management tasks. The OS automatic execution management unit 140 supports stable operation even when a user lacks expertise in system management.

The OS automatic execution management unit 140 may include, for example, a system security management function and a software package management function.

Through automatic security management, abnormal access or behavior is detected in real time and blocked in conjunction with an intrusion detection system, and automatic restoration to a previous normal state is performed when operating system settings are unintentionally changed.

Also, through software package management, software installation, update, and maintenance are automatically managed, whereby the latest security patches and function updates may be applied in a timely manner.

The automatic management functions are performed in the background without direct intervention by a professional user and support maintaining the system in an optimal state. Also, the automatic management functions may be configured to, when a user makes a query or request through a natural language interface, analyze a current system state and provide analysis results to the user or automatically perform a necessary action.

Specifically, the OS automatic execution management unit 140 may include a code execution and system recovery module 141, an intrusion detection and security module 142, and a software package management module 143.

The code execution and system recovery module 141 is configured to safely and efficiently execute code in the operating system and automatically perform recovery when a problem occurs during execution. The operating system performs various tasks in response to a user request, but an error may occur or settings may be corrupted during execution, and thus a stable recovery mechanism is required to handle such errors or corruption.

The code execution and system recovery module 141 is configured to analyze the state before and after code execution using an AI-based code execution review function, detect an error during execution, and perform an automatic recovery procedure when necessary.

For example, when a user requests execution of a specific script for system performance optimization and an unexpected error or performance degradation occurs during execution, the code execution and system recovery module 141 automatically performs a recovery or rollback procedure to maintain the system in a normal state.

Specifically, the code execution and system recovery module 141 may perform the following operations.

First, the code execution and system recovery module 141 performs AI-based code execution and error detection, thereby performing security review and error prediction analysis prior to execution of AI-generated code and detecting a problem immediately upon occurrence.

Second, the code execution and system recovery module 141 restores the system to its original state or applies an alternative solution through an automatic recovery and rollback function when an error occurs or system settings are corrupted during code execution. For example, when a problem occurs after changing operating system settings, the code execution and system recovery module 141 rolls back the settings or proposes an alternative solution.

Third, the code execution and system recovery module 141 continuously monitors CPU usage, memory usage, and network usage during code execution through real-time system monitoring and state checking and immediately performs a recovery action when an abnormal operation is detected.

Fourth, the code execution and system recovery module 141 records and analyzes an execution history and logs and utilizes the results for AI model improvement to enable automatic response when a similar problem occurs.

Fifth, the code execution and system recovery module 141 automatically generates and executes a recovery script to execute an appropriate recovery command or script for responding to an analyzed problem, thereby restoring the operating system to a normal state.

The intrusion detection and security module 142 is configured to continuously monitor the security state of the operating system and detect and respond to security threats in real time.

In a modern operating system environment, various security threats, such as malware, unauthorized access, and vulnerability-based attacks, exist, and thus intelligent analysis and automatic response functions are required. The intrusion detection and security module 142 is configured to detect abnormal behavior using an AI-based analysis technique and automatically perform a response action thereto.

For example, when an abnormal access pattern is detected by analyzing a system log and network traffic using AI, the intrusion detection and security module 142 may automatically block a connection associated therewith and generate a security warning. Also, the latest security threat data is learned and incorporated, whereby new attack types that are difficult to detect by existing security solutions may be identified.

Specifically, the intrusion detection and security module 142 may perform the following functions.

First, as a real-time intrusion detection and response function, the intrusion detection and security module 142 detects unauthorized access, malfunction of an internal system, and suspicious execution by continuously monitoring the operating system and network activities and performs immediate blocking and isolation in response thereto.

Second, as a security vulnerability search and automatic patch application function, the intrusion detection and security module 142 periodically checks system security settings and automatically applies a security patch or provides a warning to an administrator when a vulnerability is found.

Third, as a network security and firewall rule optimization function, the intrusion detection and security module 142 detects anomalies and blocks abnormal connections by analyzing network traffic and dynamically adjusts firewall rules to block unnecessary ports or apply rules reflecting specific attack patterns.

Fourth, as an abnormal behavior analysis and blocking function, the intrusion detection and security module 142 learns normal process execution patterns and performs immediate blocking and recovery actions when abnormal behavior, such as a root privilege escalation attempt, random port scanning, or unauthorized file changes, is detected.

Fifth, as an AI-based threat intelligence utilization function, the intrusion detection and security module 142 detects new security threats and attack patterns and proactively performs response actions thereto using the latest security threat database and AI analysis techniques.

The software package management module 143 is a component configured to automatically manage software and package updates in the operating system and perform optimized installation and maintenance of packages.

An operating system requires continuous package updates and security patches, but these processes are complicated and have a high likelihood of errors when directly managed by a user. Accordingly, the software package management module 143 is configured to automatically install, update, and manage necessary packages using an AI-based package management function to maintain a stable and optimized package environment.

For example, a package requiring the latest security update is automatically identified by AI, and the update may be safely applied after analyzing the package dependencies and compatibility. Further, an unnecessary package installed in the system may be detected and automatically removed, and resource usage may be optimized.

Specifically, the software package management module 143 may perform the following functions.

First, as a package update automation and optimization function, the software package management module 143 automatically detects a software package required for the operating system, updates the software package to the latest version, and selects a stable update path by predicting potential problems after the update.

Second, as a package dependency analysis and conflict resolution function, when updating a specific package, the software package management module 143 detects the possibility of conflicts with other packages in advance by analyzing dependencies between packages and presents a solution thereto.

Third, as a security patch and vulnerability management function, the software package management module 143 identifies packages to which the latest security patch has not been applied, automatically applies the patches or provides a security warning, and proposes an update or an alternative solution when a specific package is associated with recently disclosed security vulnerabilities (CVE).

Fourth, as an unnecessary package search and automatic removal function, the software package management module 143 detects unused or old packages and automatically removes or cleans them up, thereby securing disk space and enabling efficient use of system resources.

Fifth, as a system environment-specific package management function, the software package management module 143 analyzes the operating environment of the system and user requirements and recommends and applies appropriate package versions and configurations. For example, settings may be made such that a version having verified stability is maintained in server environments and a package including the latest functions is preferentially applied in development environments.

When a management function that needs to be autonomously performed by an operating system exists in addition to the above-described functions, the function may be included in the OS automatic execution management unit 140 and performed.

Referring again to FIG. 3, the platform data integrated management unit 150 collects, stores, and analyzes various kinds of data generated throughout the operating system, thereby serving as a data hub that supports AI-based optimization and automation of operations.

The platform data integrated management unit 150 is configured to maintain stable operation of the operating system, accurately process user requests, and collect and manage system data 151, operating system data 152, user data 153, and platform data 154 in an integrated manner to support continuous training and improvement of the AI model.

The platform data integrated management unit 150 manages an operating system log, performance metrics, user settings information, usage pattern information, and data related to cloud or edge platforms in an integrated manner and provides the data to the AI model-based engine 130 and the agent unit 120, thereby supporting more accurate decision-making and prediction.

For example, previous task execution results and system state information at that time may be used as training data, whereby processing speed and accuracy may be improved when a similar task is performed. Accordingly, an OS automation system may be stably and efficiently operated, and overall efficiency of the AI-based operation and management process may be improved.

Here, the system data 151 includes key information for monitoring and analysis of the overall state of the operating system and hardware.

The OS automation system identifies the current system state in real time based on system data, detects abnormal operation, and adjusts resource allocation, thereby managing system performance.

For example, when an abnormal increase in CPU usage is detected, the increase is analyzed by AI, and actions such as automatically terminating unnecessary processes or allocating more resources to a high-priority task may be performed.

The following functions may be performed with respect to the system data 151.

First, as a real-time system performance monitoring function, data such as CPU usage, memory usage, disk usage, and network traffic is continuously collected, and system performance is evaluated based on the collected data.

Second, as an anomaly detection and alert function, when an overload state or abnormal resource usage is detected, an administrator is notified of the state or automatic response is performed.

Third, as a system log and event recording function, major events, such as process execution, error occurrence, and service initiation and termination, are stored and analyzed to track the operating state.

Fourth, as a hardware state checking and maintenance support function, CPU temperature, battery state, and storage device state are analyzed to detect hardware anomalies early, and the analyzed information is used to establish a maintenance plan.

The operating system data 152 includes operating system setting information, service states, software package information, and an update history. This data is used as basic information for ensuring stable operation of the operating system and for supporting optimization and automatic management of the operating system by AI.

For example, when AI determines that specific software requires an update, operating system data is analyzed to predict changes in settings or effects on the system that are expected when the update is applied, and an appropriate update strategy may be established based on the analysis.

The following functions may be performed with respect to the operating system data 152.

First, as an operating system settings management function, main setting information, such as network configuration, a security policy, and user authorization settings, is stored, and a change history is managed, thereby supporting optimization and recovery of settings by AI.

Second, as an operating system service and process state monitoring function, currently running processes, service states, and background tasks are monitored, thereby enabling efficient process management and resource allocation by AI.

Third, as a software and package information management function, a list of installed software, version information, and update records are maintained, thereby supporting application of the latest patches and removal of unnecessary software by AI.

Fourth, as an operating system update and security patch record management function, an update history and a security patch application state are recorded, thereby supporting prevention of security vulnerabilities and maintenance of the system in an up-to-date state.

The user data 153 includes system usage patterns, preference settings, and a task history of an individual user. By utilizing this data, AI may provide a user-specific operating system management function and configure a user experience in a personalized manner.

For example, when a user repeatedly performs a specific task, AI may learn the pattern, and related tasks may be configured to be automatically performed without an explicit command from the user. Further, a function for applying personalized security settings or recommending and automatically configuring software preferred by a user may be implemented.

The following functions may be performed with respect to the user data 153.

First, as a user settings and preference analysis function, an environment optimized for an individual user is provided by learning usage patterns of the user in the operating system. For example, when a user usually uses dark mode, the same settings may be automatically applied on a new device.

Second, as a task history analysis and automation recommendation function, commands and tasks frequently performed by a user are recorded and analyzed, thereby enabling automation of repeated tasks or recommendation of related functions.

Third, as a user security settings management function, security requirements, such as two-factor authentication, an automatic lock policy, and restrictions on access to a specific network, are analyzed, and appropriate security measures are recommended or automatically applied.

Fourth, as a multi-user and account management function, when a plurality of users are present in the operating system, user-specific settings are stored and managed, thereby supporting each user's environment to be independently maintained.

The platform data 154 is a dataset for integrated management of various kinds of data generated in main components of the operating system AI agent platform, such as agents, the AI natural language interface, the AI model-based engine 130, the OS automatic execution management unit 140, and the platform data integrated management unit 150.

The operating system AI agent platform generates large amounts of data in processing user requests, training AI models, and automating the operating system, and the generated data is used as core assets for operating system optimization, agent function improvement, system recovery, and security enhancement.

For example, results obtained from code generation and execution by the AI model-based engine 130, records of tasks performed by agents, and security event logs collected by the OS automatic execution management unit 140 are accumulated as important information for future decision-making and optimization.

The following functions may be performed with respect to the platform data 154.

First, as a platform-wide data collection and integrated management function, agent activity logs, a code generation history of an AI model, security events of the OS automatic execution management unit 140, and query processing details of the natural language interface are collected and integrated, and information for platform optimization is derived by analyzing correlations among the data.

Second, as a data provision function for AI model training, an operation log and execution result data are provided to the AI model-based engine 130 to support more sophisticated code generation and optimization. That is, the patterns of tasks repeatedly performed by agents are analyzed, thereby improving the automation level of the AI model.

Third, as a platform performance optimization function, resource allocation is adjusted by analyzing details of tasks performed by agents, operations of components within the platform are monitored, and the operating environment is improved by detecting bottlenecks or inefficient processes.

Fourth, as a data analysis function for security and failure responses, real-time threat analysis and response are supported using anomaly detection data and security event logs collected by the OS automatic execution management unit 140, and recovery results are recorded. Accordingly, when a similar failure occurs, an appropriate recovery method is proposed.

Fifth, as a user interface improvement and experience optimization function, conversation flow is improved by analyzing user query patterns and feedback data, and user-customized task recommendation functions are enhanced.

Sixth, as an operating system compatibility and data migration optimization function, when platform data is moved to a new operating system environment, an optimal data migration method may be proposed and performed.

The types of data managed by the platform data integrated management unit 150 may be summarized according to their purposes, and content of collected data, usage methods, and characteristics, as shown in Table 2 below.

TABLE 2

| Data type | Main Purpose | Key Data | Usage | Characteristics |
|---|---|---|---|---|
| System | Monitoring | CPU, memory, | Anomaly | Requires real-time |
| Data | operating system | and disk usage, | detection and | monitoring and |
| | and hardware | network traffic, | automatic | immediate |
| | states and | system logs | response, system | response |
| | optimizing | | performance | |
| | performance | | analysis | |
| Operating | Managing | Operating system | Operating system | Focused on |
| System | operating system | settings, running | recovery, | maintaining |
| Data | settings, services, | processes, | optimization, and | stability and |
| | and packages | software update | automatic update | optimization of the |
| | | history | management | operating system |
| User | User-specific | User settings, | Personalized | User-specific data |
| Data | operation | usage patterns, | security settings | management |
| | optimization and | task history, | and automation | |
| | user experience | security settings | recommendations | |
| | improvement | | | |
| Platform | Performance | Agent activity | AI model training, | Used for |
| Data | optimization and | logs, AI model | operating system | optimizing overall |
| | automation of the | training data, | automation | platform |
| | operating system | operating system | optimization, | performance and |
| | AI agent platform | automatic | security and | AI operations |
| | | execution history | failure response | |

An embodiment is designed to operate smoothly in various operating system environments. For example, the embodiment may be run on existing operating systems 10, such as Windows and Linux, and is configured to execute code that is generated to be suitable for command systems and execution structures of the respective operating systems.

Also, AI accelerator hardware 20 and 30, such as GPUs and NPUs, are supported, thereby enabling efficient processing of large-scale computation of the AI model-based engine 130. Accordingly, the speed of inference processing for user conversational input may be improved, and overall response performance and system processing efficiency may be improved.

FIG. 4 is a flowchart for explaining detailed operations of an AI model-based engine according to an embodiment.

Referring to FIG. 4, data within the system and external data are searched using a retrieval-augmented generation (RAG) method, and optimal information related to the task defined at step S220 of FIG. 2 is referenced in real time at step S231.

Subsequently, the transformer-based AI model receives the referenced information and automatically generates optimal executable code suitable for the operating system environment at step S232.

The generated code is analyzed using static analysis tools to verify whether security vulnerabilities or potential errors are present, and simultaneously, a performance optimization process is performed at step S233.

Subsequently, a dynamic test is performed in a sandbox environment configured to be similar to the actual operating environment, thereby detecting an error or abnormal behavior during execution at step S234.

The verified code may be transmitted to the OS automatic execution management unit 140 and applied to the actual operating system environment.

Hereinafter, an AI model customization and compression process will be described through a scenario.

The AI model customization and compression process is a procedure for continuously optimizing and compressing the AI model based on operating system usage patterns and accumulated execution data so that the AI model may operate smoothly in various operating environments.

This corresponds to a core component of the operating system AI agent platform and is described through the following user scenario example to facilitate understanding.

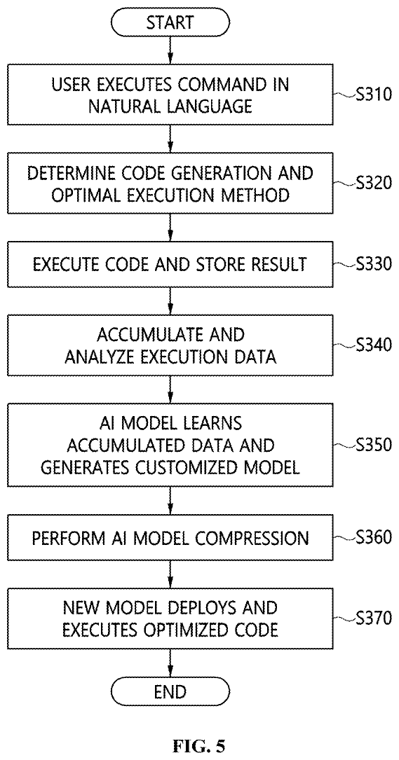

FIG. 5 is a flowchart illustrating a process in which AI learns task patterns of an operating system and determines an optimal code execution method and resource utilization method based thereon.

Referring to FIG. 5, a user inputs a natural language command to an AI-based operating system management system through the AI natural language interface 110 at step S310. For example, a command such as “clean up a system log and terminate an unnecessary process” may be input.

Accordingly, the AI model-based engine 130 analyzes the command, generates code, and determines an optimal execution method at step S320.

Here, the AI model generates an appropriate command by referring to a previous execution history, for example, previous task records related to system log cleanup and process termination. For example, a combination of commands, such as ‘journalctl --vacuum-time=1 week && pkill -f unused_process’ may be generated.

Then, the OS automatic execution management unit 140 executes the generated command in the actual operating system environment and records execution results at step S330. For example, execution results, such as the capacity of removed logs and a list of terminated processes, may be stored in the platform data integrated management unit 150.

Subsequently, the platform data integrated management unit 150 accumulates and analyzes execution data at step S340. Various kinds of execution-related information, such as changes in system performance, user feedback, and error occurrence information, is stored in a database, and when execution results differ from expected results, a modified command may be proposed.

Subsequently, the AI model generates a customized model based on the accumulated data at step S350. That is, the model is continuously updated by analyzing an execution history and the usage patterns of the user, and an execution method optimized for a specific user or a specific system environment is learned.

Then, at step S360, when the model size is excessively large or an excessive computational load is imposed on the model, a lightweight model is generated such that only important patterns are maintained. In this process, quantization and knowledge distillation techniques may be applied, and optimization is performed to enable the model to operate smoothly even in a CPU-based environment without a GPU or an NPU.

Finally, the generated new model is deployed and optimized code is executed based thereon at step S370. Accordingly, when the same or similar request is input again, the AI model operates to improve response speed and resource efficiency by utilizing more efficient code or cached execution results. For example, after commands frequently used by a specific user are learned, executable code more optimized for the commands may be automatically generated or quickly processed using a cache.

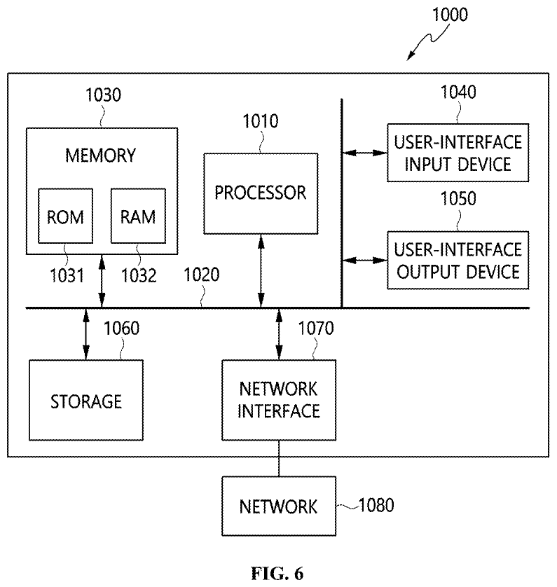

FIG. 6 is a view illustrating a computer system configuration according to an embodiment.

The apparatus 100 for managing an operating system based on an AI agent according to an embodiment and at least one of the internal components thereof may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, the following advantages are provided by automating IT operations management.

First, automation of operating system and application management may improve management efficiency and reduce human errors and omissions. Accordingly, more reliable system operation may be achieved.

Also, by presenting a new paradigm of AI-based operating system management, the creation and growth of an AI operations management market may be expected. Such technology may be widely utilized in individual user environments and enterprise IT infrastructure management and may promote the growth of related software and service industries.

Also, system security and personal information protection are enhanced by automating security setting and monitoring and by enabling real-time responses. By utilizing AI, the latest security patches may be automatically applied, and anomaly detection and immediate response may be enabled, thereby preventing security incidents and improving reliability.

Also, system sustainability and energy efficiency are improved through operating task optimization and efficient resource management. Unnecessary processes or services are automatically adjusted or terminated, and resources are utilized only when necessary, thereby reducing power consumption and extending hardware lifetime.

As described above, according to the disclosed embodiment, a user-friendly and intelligent OS management system is implemented, thereby comprehensively improving the efficiency, stability, and security of IT operations and contributing to the creation of new added value.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for managing an operating system based on an AI agent, comprising:
an AI natural language interface for recognizing a natural language command input from a user;
an agent unit for determining a task corresponding to the natural language command received from the AI natural language interface;
an AI model-based engine for generating and optimizing command code corresponding to the task determined by the agent unit using an AI model; and
an operating system automatic execution management unit for executing the command code generated by the AI model-based engine in an actual operating system and providing an execution result to the agent unit as feedback.

2. The apparatus of claim 1, wherein
the agent unit includes a chatbot conversation interface for interacting with the user in natural language, and
the chatbot conversation interface extracts an intent and key information from a natural language input from the user and generates a response while maintaining context of a previous conversation.

3. The apparatus of claim 1, wherein the agent unit includes a plurality of domain-specific agents.

4. The apparatus of claim 3, wherein the agent unit performs registration, deletion, state monitoring, and role allocation of the plurality of agents.

5. The apparatus of claim 1, wherein the agent unit splits a user request into a plurality of tasks, establishes an execution plan, and determines sequential execution or parallel execution by analyzing dependencies among the tasks.

6. The apparatus of claim 1, wherein the AI model-based engine automatically adjusts a structure of the command code corresponding to the natural language command of the user according to a type of the operating system and an operating environment.

7. The apparatus of claim 6, wherein the AI model-based engine removes unnecessary commands from the generated command code and reorders an execution order.

8. The apparatus of claim 6, wherein the AI model-based engine analyzes system resource access, file modification, network communication, process creation, or privilege escalation requests included in the generated command code and determines whether a risk exists by comparing the requests with a preset security policy.

9. The apparatus of claim 8, wherein the AI model-based engine executes the command code in an isolated sandbox environment, thereby verifying whether abnormal behavior occurs.

10. The apparatus of claim 9, wherein the AI model-based engine performs a test run of the command code in a virtual environment similar to an actual operating system environment and then transmits the command code to the operating system automatic execution management unit.

11. The apparatus of claim 6, wherein the AI model-based engine searches internal system data and an external database and reflects a search result in generating the command code.

12. The apparatus of claim 1, wherein the AI model included in the AI model-based engine is finetuned based on user behavior patterns and system usage patterns and is made lightweight by applying quantization or knowledge distillation techniques.

13. The apparatus of claim 1, wherein the operating system automatic execution management unit detects an error during code execution and performs automatic recovery or rollback when the error occurs.

14. The apparatus of claim 1, wherein the operating system automatic execution management unit detects a system security event and blocks abnormal access or processes.

15. The apparatus of claim 1, further comprising:
a platform data integrated management unit for collecting and managing system data, operating system data, user data, and platform data.

16. The apparatus of claim 15, wherein the platform data integrated management unit stores and analyzes, based on the data, a task execution history and a command code generation history of an agent, and security events.

17. A method for managing an operating system based on an AI agent, comprising:
receiving a natural language command from a user;
determining a task corresponding to the natural language command;
generating and optimizing command code corresponding to the task based on an AI model;
executing the generated command code in an actual operating system; and
providing an execution result to the user as feedback.

18. The method of claim 17, wherein determining the task comprises:
performing registration, deletion, state monitoring, and role allocation of a plurality of domain-specific agents; and
splitting a user request into a plurality of tasks, establishing an execution plan, and determining sequential execution or parallel execution by analyzing dependencies among the tasks.

19. The method of claim 17, wherein generating and optimizing the command code comprises:
automatically adjusting a structure of the command code corresponding to the natural language command of the user according to a type of the operating system and an operating environment;
analyzing system resource access, file modification, network communication, process creation, or privilege escalation requests included in the generated command and comparing the request with a preset security policy to determine whether a risk exists;
verifying whether abnormal behavior occurs by executing the command code in an isolated sandbox environment; and
searching internal system data and an external database and reflecting a search result in generating the command code.

20. The method of claim 17, wherein executing the generated command code comprises:
detecting an error during code execution and performing automatic recovery or rollback when the error occurs; and
detecting a system security event and blocking abnormal access or processes.
